(19) United States
(12) Patent Application Publication
(10) Pub. No.: US 2026/0030614 A1
(43) Pub. Date: Jan. 29, 2026

(54) SYSTEMS AND METHODS FOR PROCESSING ONLINE CHECKOUT WITH BROWSER AUTOFILL USING A SHARED WALLET

(71) Applicant: Early Waning Services, LLC, Scottsdale, AZ (US)

(72) Inventors: John Mwangi, West Orange, NJ (US); Graham Ritter, New York, NY (US); Rajesh Kulkarni, Scottsdale, AZ (US); Christian Faragalli, New York, NY (US); Lawrence Hutchison Douglas, McLean, VA (US)

(73) Assignee: Early Warning Services, LLC, Scottsdale, AZ (US)

(21) Appl. No.: 19/281,378

(22) Filed: Jul. 25, 2025

Related U.S. Application Data
(60) Provisional application No. 63/676,286, filed on Jul. 26, 2024.

(51) Int. Cl. G06Q 20/36; G06Q 20/34; G06Q 20/38; G06Q 20/40

(52) U.S. Cl. CPC G06Q 20/3674; G06Q 20/34; G06Q 20/385; G06Q 20/4016

(57) ABSTRACT

A computer-implemented method including receiving, at a wallet server, a request from a browser server for payload information associated with a selected payment instrument for an online checkout transaction. The method also can include performing, by the wallet server, a risk assessment for the selected payment instrument. The method additionally can include determining whether to perform a step-up authentication based on the risk assessment. The method further can include, upon determining to proceed with the online checkout transaction, requesting, by the wallet server, token information from a token service provider. The method additionally can include receiving, at the wallet server, the token information from the token service provider. The method further can include creating, by the wallet server, a secure payload comprising the token information. The method additionally can include sending, by the wallet server, the secure payload to the browser server for autofill in a browser. Other embodiments are described.

### CROSS-REFERENCE TO RELATED APPLICATION

This application claims the benefit of U.S. Provisional Application No. 63/676,286, filed Jul. 26, 2024. U.S. Provisional Application No. 63/676,286 is incorporated herein by reference in its entirety.

### TECHNICAL FIELD

This disclosure relates generally to processing online checkout transactions within browser autofill using a shared wallet.

### BACKGROUND

Conventional online checkout typically involves a user providing card details to the merchant for the transaction. The merchant often provides the option to store the card information so that the user is not asked for the card information the next time the user does an online checkout at the same merchant. User often have multiple different cards, which are often issued by multiple different card issuers. Additionally, users often use websites of many different merchants, each with their own checkout system.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for processing, facilitating, providing, or using online checkout with browser autofill using a shared wallet, according to an embodiment;

FIG. 4 illustrates a flow diagram of a data flow between system components of the system of FIG. 3 to initiate a checkout process that facilitates a purchase through browser autofill;

FIG. 5 illustrates a sequence diagram of a method of processing a checkout using autofill;

FIG. 6 illustrates an exemplary display screen of a graphical user interface of a website displayed on a user device used by a user to initiate the checkout process for the purchase or payment of one or more items;

FIG. 7 illustrates an exemplary display screen that is an update of the display screen of FIG. 6, showing when the user selects a payment instrument;

FIG. 8 illustrates an exemplary display screen that is an update of the display screen of FIG. 7, showing further processing performed by a browser server after the user selected the payment instrument on the display screen of FIG. 7;

FIG. 9 illustrates an exemplary display screen that is an update of the display screen of FIG. 8, prompting the user to participate in the OTP challenge;

FIG. 10 illustrates an exemplary display screen that is an update of the display screen of FIG. 9, prompting the user to enter the OTP code;

FIG. 11 illustrates an exemplary display screen that is an update of the display screen of FIG. 10, showing the payload received for the transaction on the browser;

FIG. 12 illustrates an exemplary display screen that is an update of the display screen of FIG. 11, showing the payment information having been received by the merchant;

FIG. 13 illustrates a flowchart for a method of processing online checkout with browser autofill using a shared wallet, according to an embodiment; and

FIG. 14 illustrates a flowchart for a method of processing online checkout with browser autofill using a shared wallet, according to an embodiment.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, two minutes, or five minutes.

### DESCRIPTION OF EXAMPLES OF EMBODIMENTS

Various embodiments include a computer-implemented method. The method can include receiving, at a wallet server, a request from a browser server for payload information associated with a selected payment instrument for an online checkout transaction. The method also can include performing, by the wallet server, a risk assessment for the selected payment instrument. The method additionally can include determining whether to perform a step-up authentication based on the risk assessment. The method further can include, upon determining to proceed with the online checkout transaction, requesting, by the wallet server, token information from a token service provider. The method additionally can include receiving, at the wallet server, the token information from the token service provider. The method further can include creating, by the wallet server, a secure payload comprising the token information. The method additionally can include sending, by the wallet server, the secure payload to the browser server for autofill in a browser.

A number of embodiments include a system including one or more processors and one or more non-transitory computer-readable media storing computing instructions that, when executed on the one or more processors, cause the one or more processors to perform operations. The operations can include receiving a request from a browser server for payload information associated with a selected payment instrument for an online checkout transaction. The operations also can include performing a risk assessment for the selected payment instrument. The operations additionally can include determining whether to perform a step-up authentication based on the risk assessment. The operations further can include, upon determining to proceed with the online checkout transaction, requesting token information from a token service provider. The operations additionally can include receiving the token information from the token service provider. The operations further can include creating a secure payload comprising the token information. The operations additionally can include sending the secure payload to the browser server for autofill in a browser.

Further embodiments include one or more non-transitory computer-readable media storing computing instructions that, when executed on the one or more processors, cause the one or more processors to perform operations. The operations can include receiving a request from a browser server for payload information associated with a selected payment instrument for an online checkout transaction. The operations also can include performing a risk assessment for the selected payment instrument. The operations additionally can include determining whether to perform a step-up authentication based on the risk assessment. The operations further can include, upon determining to proceed with the online checkout transaction, requesting token information from a token service provider. The operations additionally can include receiving the token information from the token service provider. The operations further can include creating a secure payload comprising the token information. The operations additionally can include sending the secure payload to the browser server for autofill in a browser.

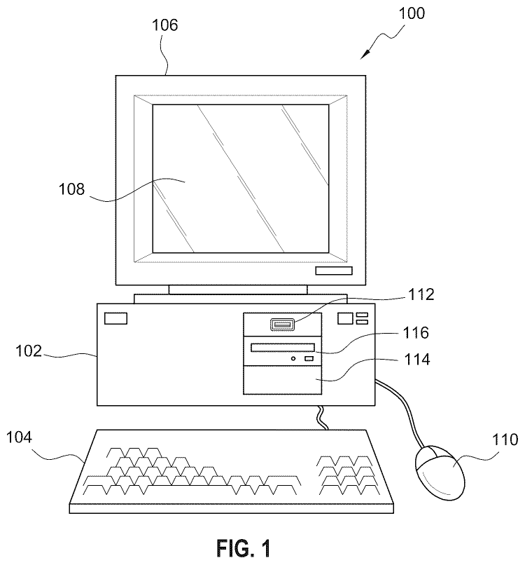

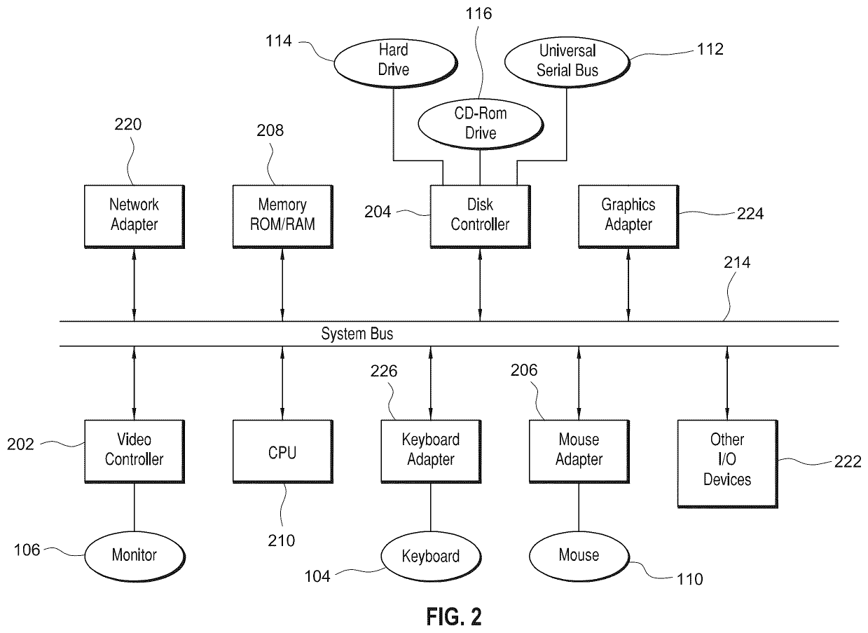

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) or Field Programmable Gate Arrays (FPGAs) can be programmed to carry out one or more of the systems and procedures described herein. For example, one or more of the programs and/or executable program components described herein can be implemented in one or more ASICs or FPGAs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

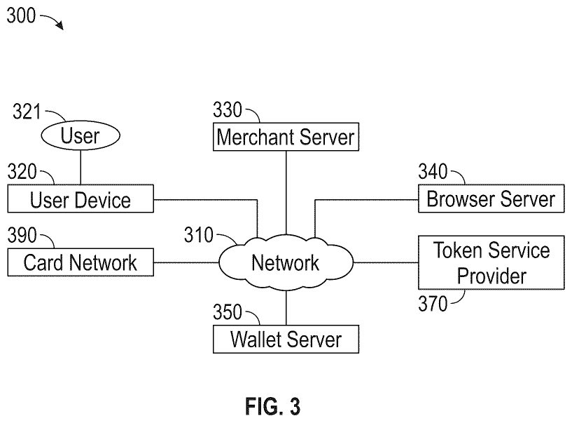

Turning ahead in the drawings, FIG. 3 illustrates a block diagram of a system 300 that can be employed for processing, facilitating, providing, or using online checkout with browser autofill using a shared wallet, according to an embodiment. System 300 is merely exemplary, and embodiments of the system are not limited to the embodiments presented herein. The system can be employed in many different embodiments or examples not specifically depicted or described herein. In some embodiments, certain elements of system 300 can perform various procedures, processes, and/or activities. In other embodiments, the procedures, processes, and/or activities can be performed by other suitable elements of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include various systems, such as one or more user devices (e.g., user device 320) used by one or more users (e.g., user 321), one or more merchant servers (e.g., merchant server 330), one or more browser servers (e.g., browser server 340), a wallet server 350, one or more token service providers (e.g., token service provider 370), and one or more card networks (e.g., card network 390). In some embodiments, the systems of system 300 can be in data communication with each other through a network 310. Network 310 can be the Internet or another suitable network, or multiple different networks. In some embodiments, network 310 can be public or private, or can include one or more public networks and one or more private networks.

The systems of system 300, such as user device 320, merchant server 330, browser server 340, wallet server 350, token service provider 370, and/or card network 390, can each be a computer system, such as computer system 100 (FIG. 1), as described above, and can each be a single computer, a single server, or a cluster or collection of computers or servers, or a cloud of computers or servers. In another embodiment, a single computer system can host multiple systems of system 300. In some embodiments, wallet server 350 can be provided and/or operated by an entity that is different from the entities operating merchant server 330, browser server 340, token service provider 370, and/or card network 390.

In many embodiments, merchant server 330 can be operated by one or more merchants, which can host one or more websites. For example, merchant server 330 can host a website displayed on user device 320, which can allow users 321 (e.g., consumers) to search for items (e.g., products, grocery items), to add items to an electronic cart, and/or to purchase items through an online merchant checkout process, in addition to other suitable activities. The website hosted by merchant server 330 can provide a payment application to users 321 using user devices 320. The payment application can provide the online merchant checkout process to user devices 320, to allow user 321 to make a payment.

User device 320 can run a web browser to view the various pages of the website and/or payment application. For example, the browser can be any suitable browser, such as Google Chrome, Microsoft Edge, Apple Safari, Mozilla Firefox, etc. In many embodiments, browser server 340 can be associated with a particular type of browser. For example, a Google browser server can be associated with the Google Chrome web browser, and a Microsoft browser server can be associated with the Microsoft Edge web browser.

In many embodiments, wallet server 350 can provide wallet services to provide a shared wallet for multiple payment cards (e.g., credit cards, debit cards, etc.), such as from various different issuers. The payment cards each can be associated with a particular card network (e.g., card network 390). For example, a first payment card can be associated with the first card network, and a second payment card can be associated with the second card network. The first payment card can be provided by a different issuer than the second payment card, and/or the first payment network can be different from the second card network. In several embodiments, wallet server 350 can provide wallet services to multiple different merchants (individually or simultaneously), each using a merchant server (e.g., 330).

In certain embodiments, user devices 320 can be desktop computers, laptop computers, mobile devices, and/or other endpoint devices used by one or more users (e.g., user 321). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, and/or (ii) the Android™ operating system developed by the Open Handset Alliance.

In many embodiments, the systems of system 300 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the systems of system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of the system of systems 300. In a similar manner, the processors and/or the non-transitory computer-readable media can be local and/or remote to each other.

Meanwhile, in many embodiments, the systems of system 300 also can be configured to communicate with one or more databases. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, the systems of system 300, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In a number of embodiments, card network 390 can be operated by payment networks (e.g., Visa, MasterCard, Discover, American Express, etc.). Card networks 390 can facilitate transactions between merchants (e.g., merchants operating merchant servers (e.g., 330)) and issuers by interfacing with token service providers (e.g., token service provider 370). Token service provider 370 can provide token services, such as tokenizing payment cards and/or provision of such tokens.

In various embodiments, wallet server 350 can create and/or store a wallet for each user (e.g., 321) in wallet directory. The wallet directory can include a single shared wallet for a user (e.g., 321) that can be used for multiple different payment cards associated with the user, including multiple cards from different issuers. In many embodiments, the user can be identified based on the email address or phone number of the user, so that a merchant can provide the email address or phone number of the user to the wallet server 350 to access the cards associated with the user in wallet server 350. In many embodiments, a wallet directory can be centralized, so that it handles payment cards across multiple issuers. In many embodiments, wallet server 350 can provide the wallet services, such as delivering payment credentials to merchant server 330. For example, the wallet services can be the Paze service provided by Early Warning Services, LLC, of Scottsdale, Arizona, or another suitable wallet service.

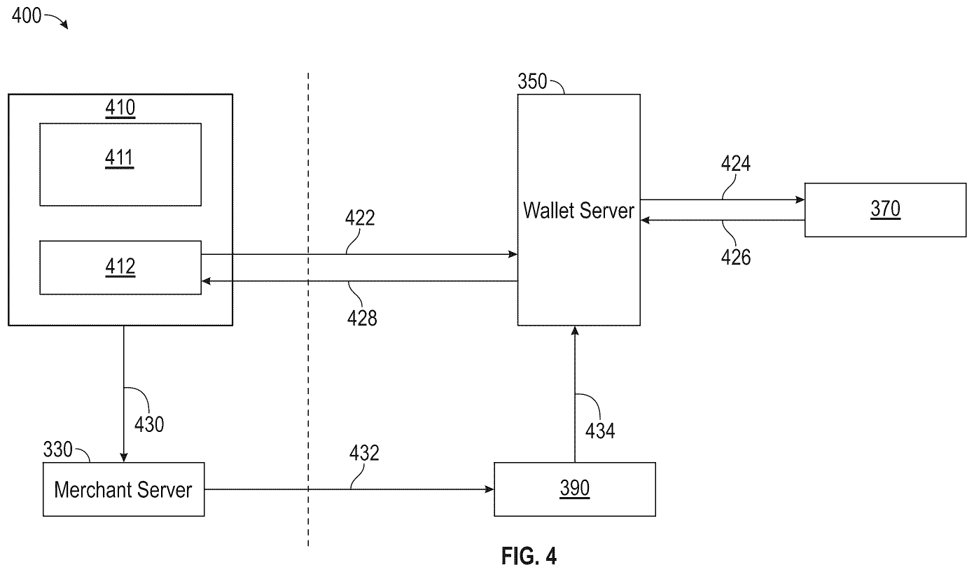

Turning ahead in the drawings, FIG. 4 illustrates a flow diagram of a data flow 400 between system components (of system 300 (FIG. 3)) to initiate a checkout process that facilitates a purchase through browser autofill. Data flow 400 is merely exemplary and is not limited to the embodiments presented herein. Data flow 400 can be employed in many different embodiments or examples not specifically depicted or described herein. In some embodiments, the procedures, the processes, and/or the activities of data flow 400 can be performed in the order presented. In other embodiments, the procedures, the processes, and/or the activities of data flow 400 can be performed in any suitable order. In still other embodiments, one or more of the procedures, the processes, and/or the activities of data flow 400 can be combined or skipped.

In many embodiments, system 300 and/or the components thereof can be suitable to perform data flow 400 and/or one or more of the operations, actions, and/or activities of data flow 400. In these or other embodiments, one or more of the operations, actions, and/or activities of data flow 400 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

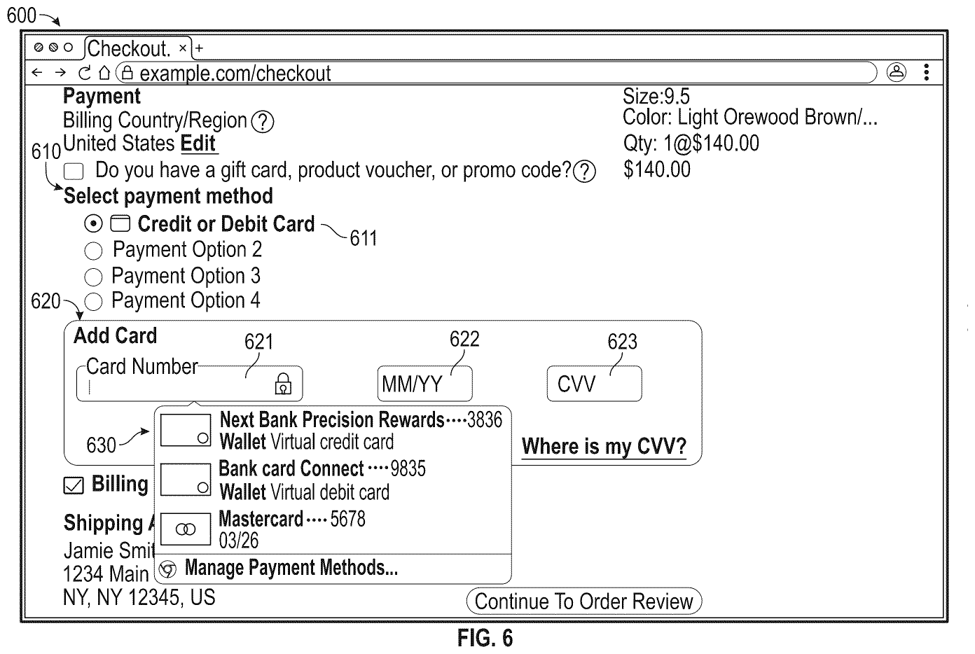

In many embodiments, data flow 400 can include an activity 410 of browser autofill, upon a user (e.g., 321 (FIG. 3)) initiating a checkout process of a merchant website through the browser displayed on a user device (e.g., 320 (FIG. 3)). In many embodiments, activity 410 can include an activity 411 of the browser displaying one or more payment cards from the wallet with the wallet icon. For example, FIG. 6 illustrates an exemplary display screen 600 of a graphical user interface (GUI) of a website displayed on a user device (e.g., 320 (FIG. 3)) used by a user (e.g., 321 (FIG. 3)) to initiate the checkout process for the purchase or payment of one or more items. Display screen 600 can be displayed when the user initiates a purchase, such as by selecting a checkout button on a merchant webpage. In many embodiments, display screen 600 shows a payment portion of the checkout webpage provided by a merchant. Display screen 600 can include a payment selection prompt 610 to prompt the user to select a payment option or payment method. For example, the user can select a payment card option 611, upon which display screen 600 can display add card fields 620, such as a card number field 621, an expiration date field 622, and a verification value field 623 for the card. In many embodiments, the verification value can be a security and/or verification measure used by the card payment network. For example, a card verification value (CVV) is a multi-digit code used for verification by the Visa payment network and a card verification code (CVC) is a multi-digit code used for verification by the Mastercard payment network.

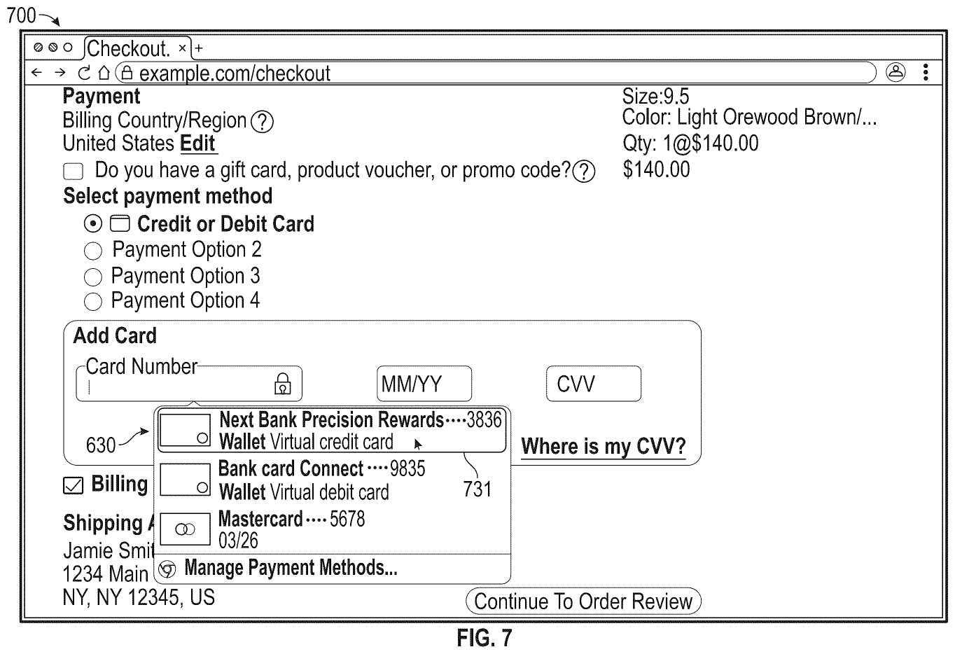

In many embodiments, when the user clicks on, taps in, or otherwise selects card number field 621, a payment instruments autofill pop-up 630 can be displayed on display screen 600. Payment instruments autofill pop-up 630 can include various payment instruments that have been saved by the user in the browser. For example, as shown in FIG. 6, payment instruments autofill pop-up 630 can include a card list with one or more cards. For example, as shown in FIG. 6, there can be three cards issued by various banks. The card list can include, for each card, a card image and/or a card descriptor. The card descriptor can include a name of the issuer, the card name (which in some cases includes the name of the issuer), and/or other identifying information for the card, such as the last four digits of the card number. As shown in FIG. 6, the first two cards in the card list include an icon or other description indicating they are associated with wallet server 350. In many embodiments, the cards associated with wallet server 350 can be processed as virtual payment cards, which can beneficially provide added security by using the actual primary account number (PAN) of the payment card. The user can select the desired card in the card list, as shown in FIG. 7 and described below, or the user can enter the card number or other information associated with a desired card. In many embodiments, the cards listed are those saved by the browser and utilized for browser autofill, as shown in FIG. 6. Other browsers on the user device (e.g., 320 (FIG. 3)) do not necessarily display or otherwise have the same cards, as the user (e.g., 321 (FIG. 3)) may have saved different sets of cards to different browsers on the user device. For example, if the user is using the Google Chrome browser and saves a card to the Google Chrome browser, that action of saving the card to the Google Chrome browser generally will not save that card to the Microsoft Edge browser on the user device.

Returning to FIG. 4, in many embodiments, activity 410 also can include an activity 412 of the user paying with autofill. For example, FIG. 7 illustrates an exemplary display screen 700 that is an update of display screen 600, showing when the user selects a payment instrument 731. As shown in FIG. 7, display screen 700 shows payment instrument 731 selected, which the user can do to make the payment using payment instrument 731. In many embodiments, selection of payment instrument 731 can result in the browser communicating with browser server 340 (FIG. 3) to initiate the payment using payment instrument 731.

As shown in FIG. 4, data flow 400 can next include an activity 422 of browser server 340 (FIG. 3) requesting token and/or payload information for the selected payment instrument (e.g., 731 (FIG. 7)) from wallet server 350. In some embodiments, upon selection of a payment credential associated with wallet server 350, wallet server 350 can perform a risk assessment. In some embodiments, the result of the risk assessment can be (i) to proceed, (ii) to perform a step-up authentication (such as requesting a one-time passcode (OTP) or the verification value (e.g., CVV or CVC) associated with the payment instrument), or (iii) to not proceed with the transaction. For example, the risk analysis can be based on whether the user has previously, or recently, performed a step-up authentication, or other suitable factors.

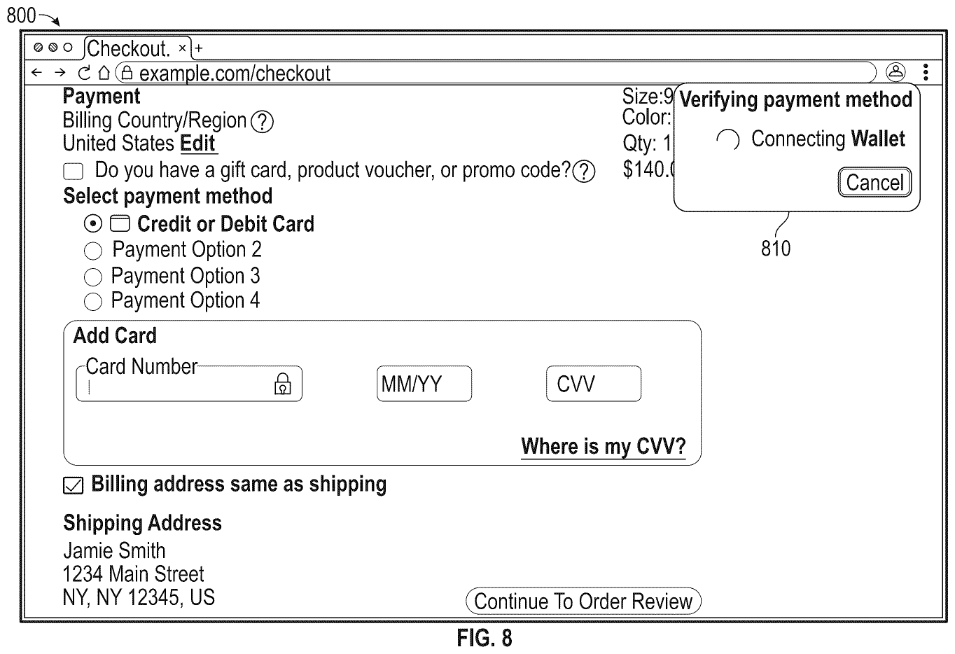

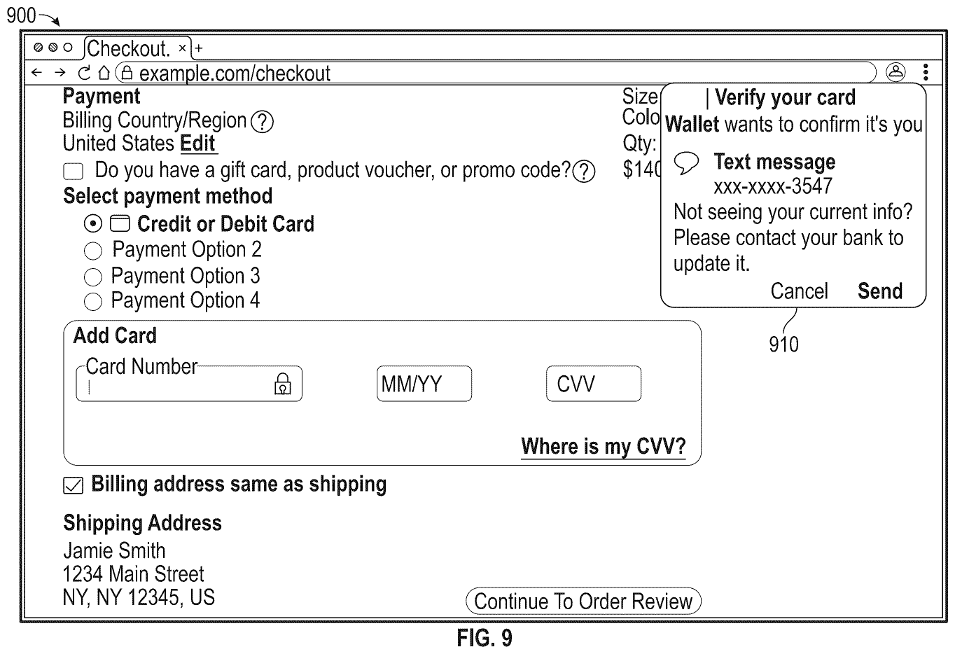

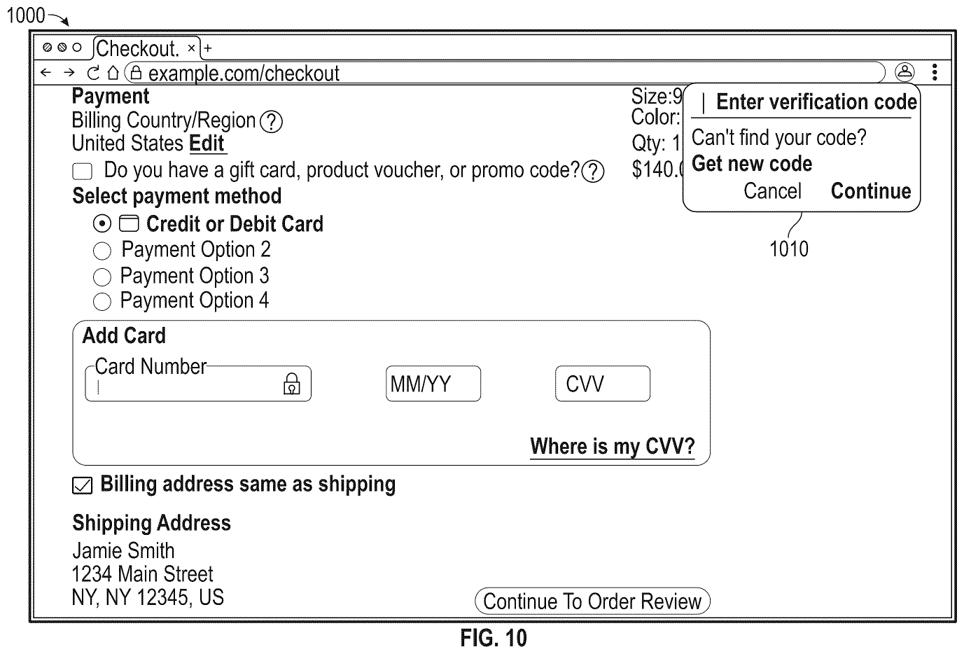

For example, FIG. 8 illustrates an exemplary display screen 800 that is an update of display screen 700, showing further processing performed by browser server 340 (FIG. 3) after the user selected payment instrument 731 on display screen 700. As shown in FIG. 8, display screen 800 shows a status indicator 810 displayed on the browser indicating a verification of the payment method by contacting the wallet server (e.g., 350). If the risk assessment performed by wallet server 350 determines that a step-up OTP verification is to be performed, status indicator 810 can be updated, as shown in FIG. 9. FIG. 9 illustrates an exemplary display screen 900 that is an update of display screen 800, prompting the user to participate in the OTP challenge. As shown in FIG. 9, display screen 900 shows an OTP prompt 910 that shows a portion of the phone number associated with the user, and a send and cancel button. OTP prompt 910 can allow the user to verify that the phone number and send the OTP via text message (e.g., SMS (short message service)) to that phone number, or else cancel the transaction. FIG. 10 illustrates an exemplary display screen 1000 that is an update of display screen 900, prompting the user to enter the OTP code. As shown in FIG. 10, display screen 1000 shows a verification code prompt 1010 that asks the user to enter the code (e.g., OTP) sent to the mobile phone of the user. Once the user enters the code, the code can be verified, and if confirmed as correct, the transaction can proceed, and/or a verification value step-up can be performed, which can involve asking for the verification value (e.g., CVV or CVC) on the payment card for the payment instrument selected.

Returning to FIG. 4, in many embodiments, upon proceeding, data flow 400 can next include an activity 424 of wallet server 350 requesting token and/or payload information from token service provider 370, followed by an activity 426 of token service provider 370 sending the token and/or payload information to wallet server 350, and an activity 428 of wallet server 350 sending the token and/or payload information to browser server 340 (FIG. 3) to be provided to the browser.

In some embodiments, the format of the token can differ depending on the payment card type. For example, cards utilizing the Visa payment network can use dynamic token validation value (DTVV), which can be unique for the browser-initiated transaction, while cards using the Mastercard payment network can use dynamic token validation code (DTVC), which can be unique for every browser-initiated transaction. Wallet server 350 and/or card network (payment network) 390 can provide the token and/or payload information for browser server 340 (FIG. 3) to autofill in the browser. In some embodiments, wallet server 350 can send a payment payload to browser server 340 (FIG. 3) to be populated by autofill in the browser. In many embodiments, the payload can include a token, an expiration date, a verification value (e.g., CVV or CVC), and/or other suitable information. For example, the token can be 15-16 digits, the expiration date can be 4 digits, and/or the verification value (e.g., CVV or CVC) can be 3-4 digits. In many embodiments, this payload information can provide information for a virtual credit card, which can utilize a virtual card number or other such identifier that is different from the card number and/or other information on the actual payment card, but can be mapped to the actual payment card in wallet server 350, card network 390, and/or token service provider 370. In many embodiments, the payload can be capable of handling authorization, clearing, and/or settlement through card network 390. In many embodiments, the payload information can be utilized to provide a dynamic virtual credit card number that changes at a defined period (e.g., start of each transaction, checkout at new merchant, daily, weekly, etc.), such that different virtual card details and any associated virtual card data can be generated at the defined trigger or defined period and mapped to the actual payment card in wallet server 350. In many embodiments, the payload can use payment network tokens. In many embodiments, the payload can use a token reference ID (TRID) for wallet server 350. In many embodiments, the payload can support merchant-initiated transactions.

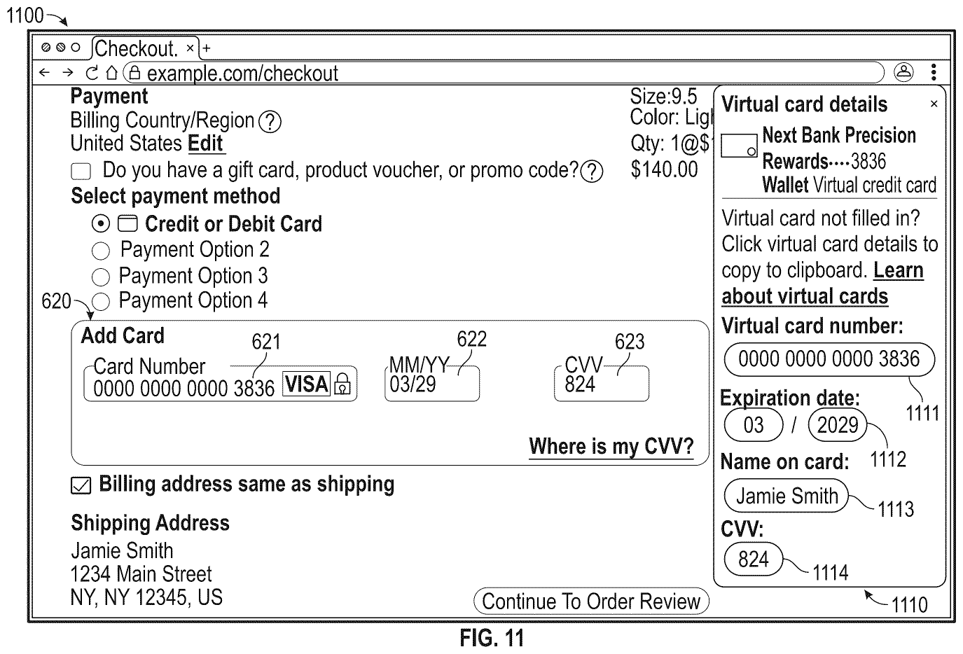

For example, FIG. 11 illustrates an exemplary display screen 1100 that is an update of display screen 1000, showing the payload received for the transaction on the browser. As shown in FIG. 11, display screen 1100 includes virtual card information 1110, which includes a card number field 1111, an expiration date field 1112, a name field 1113, and a verification value field 1114 (e.g., CVV or CVC). This information in virtual card information can be populated from the payload received. In many embodiments, this information can be added (as an autofill) to add card fields 620, such as card number field 621, expiration date field 622, and verification value field 623. In many embodiments, the value in the verification value fields 1114 and 623 can be the DTVV and/or DTVC for the virtual payment card.

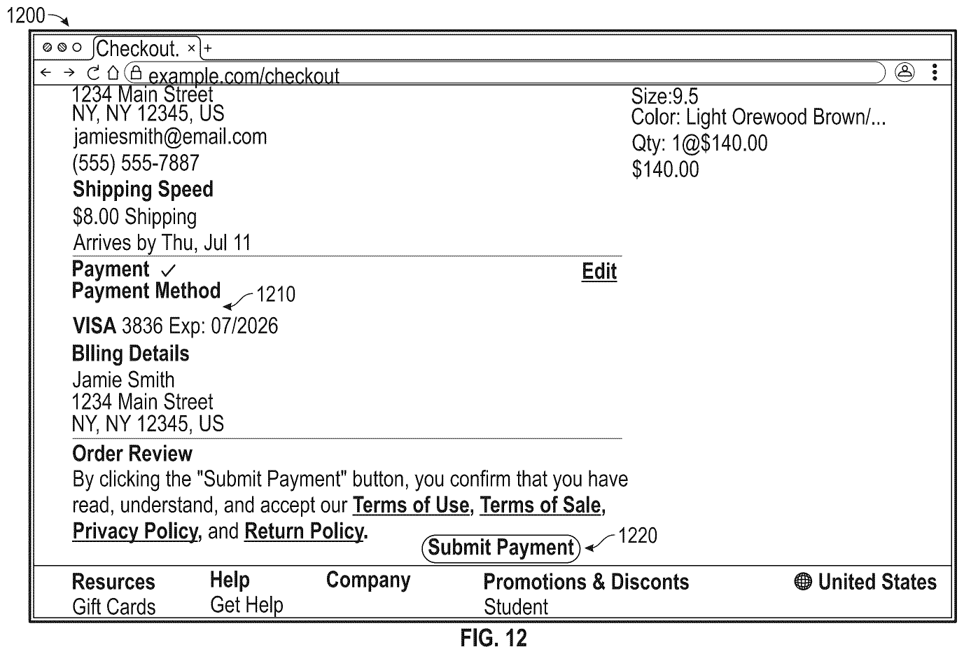

Returning to FIG. 4, in many embodiments, data flow 400 can next include an activity 430 of the browser sending the payload information to merchant server 330. For example, the payment information entered in add card fields 620 can be sent to merchant server 330. For example, FIG. 12 illustrates an exemplary display screen 1200 that is an update of display screen 1100, showing the payment information having been received by the merchant. As shown in FIG. 12, display screen 1200 includes payment information 1210, which includes a portion of the virtual card number and an expiration date. With the payment method confirmed, the user can then select a submit payment button 1220 to process the payment using the payment method.

Returning to FIG. 4, in many embodiments, data flow 400 can next include an activity 432 of merchant server 330 processing the payment by sending the payment information to card network (payment network) 390 and/or token service provider 370. In many embodiments, data flow 400 can include an activity 434 of card network (payment network) 390 and/or token service provider 370 sending token notification events to wallet server 350, such as when the token has been used, been updated, has expired, etc.

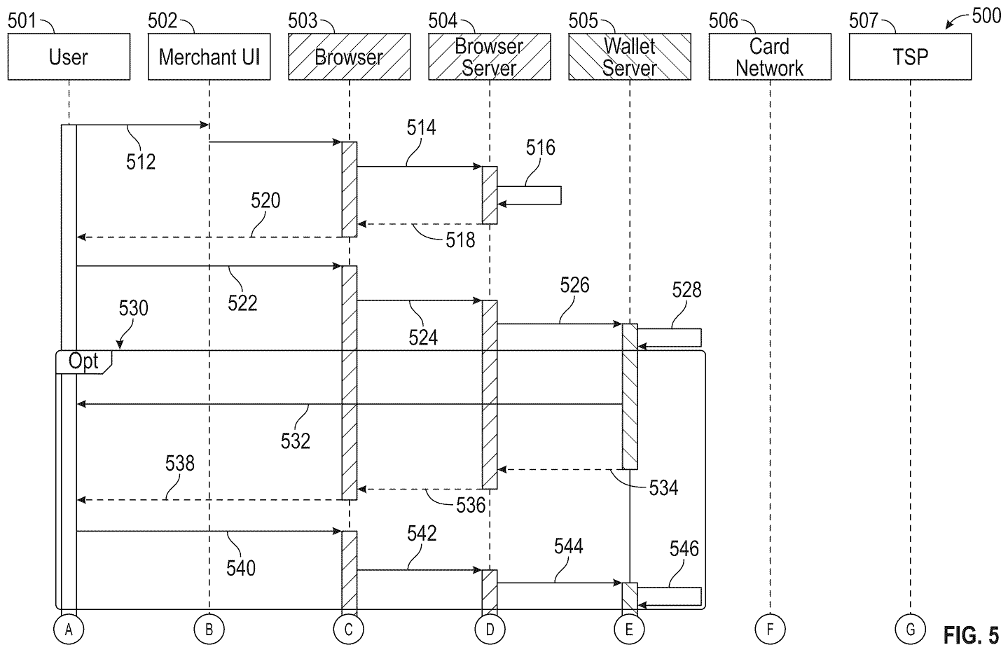

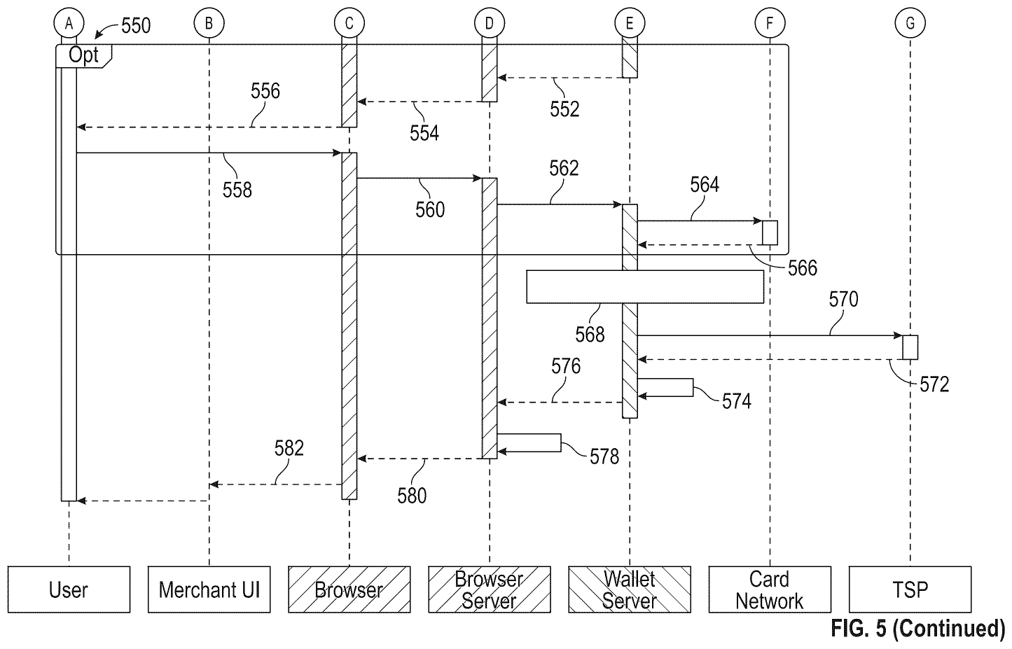

Turning ahead in the drawings, FIG. 5 illustrates a sequence diagram of a method 500 of processing a checkout using autofill. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 and/or the components thereof can be suitable to perform method 500 and/or one or more of the operations, actions, and/or activities of method 500. In these or other embodiments, one or more of the operations, actions, and/or activities of method 500 can be implemented as one or more computing instructions configured to run on one or more processors and configured to be stored on one or more non-transitory computer-readable media. Such non-transitory computer-readable media can be part of a computer system such as system 300. The processor(s) can be similar or identical to the processor(s) described above with respect to computer system 100 (FIG. 1).

Referring to FIG. 5, in many embodiments, method 500 can involve various activities and/or interactions, such as messages, calls, or responses, between various systems and/or components, such as a user 501, a merchant user interface (UI) 502, a browser 503, a browser server 504, a wallet server 505, a card network 506, and/or a token service provider 507. User 501 can be similar or identical to user 321 (FIG. 3) and/or user device 320 (FIG. 3). Merchant UI can be similar or identical to the user interface that generates the display screens shown in FIGS. 6-12. Browser 503 can be similar or identical to the browser used to display the display screens shown in FIGS. 6-12. Browser server 504 can be similar or identical to browser server 340 (FIG. 3). Wallet server 505 can be similar or identical to wallet server 350 (FIG. 3). Card network 506 can be similar or identical to card network 390 (FIG. 3). Token service provider 507 can be similar or identical to token service provider 370 (FIG. 3).

In many embodiments, method 500 can begin with user 501 performing an activity 512 of tapping on (or otherwise selecting) a card number field on merchant UI 502, as displayed in browser 503. The card number field can be similar or identical to card number field 621 (FIG. 6). Method 500 can next include browser 503 making a call 514 to browser server 504 to get payment instruments for the browser. Method 500 can next include an activity 516 of browser server 504 retrieving all payment instruments for the browser, such as all cards previously used and/or saved by user 501 in the browser, including any Wallet cards (which can be cards provided by Wallet server 505) that have been used and/or saved by user 501 in the browser. Method 500 can next include browser server 504 returning a result 518 to browser 503 of the payment instruments determined in activity 516, after which browser 503 can perform an activity 520 of displaying on merchant UI 502 the payment instruments in an autofill pop-up. The autofill pop-up can be similar or identical to payment instruments autofill pop-up 630 (FIG. 6).

In many embodiments, method 500 can next include user 501 performing an activity 522 of tapping (or otherwise selecting) a Wallet card instrument displayed on merchant UI 502 in browser 503. The Wallet card instrument selected can be similar or identical to payment instrument 731 (FIG. 7). Method 500 can next include browser 503 making a call 524 to browser server 504 to indicate that the Wallet card instrument, as identified by a Wallet card ID (identifier) has been selected by the user. Method 500 can next include an activity of browser server 504 making a call 526 to wallet server 505 to get the payload associated with the Wallet card ID. In many embodiments, call 526 can specify that the request is associated with an autofill, and can additionally include additional details, such as device data for the user device and/or browser, transaction data for the transaction, and/or other suitable information. Method 500 can next include wallet server 505 performing an activity 528 of running a risk analysis to determine whether to perform a step-up authentication. If wallet server 505 indicates that an SMS OTP step-up authentication is to be performed, then optional process 530 of SMS OTP step-up authentication can be performed. In addition, or alternatively, if wallet server 505 indicates that a verification value step-up authentication is to be performed, then optional process 550 of verification value step-up authentication can be performed.

Process 530 for SMS OTP step-up authentication can include an activity 532 of wallet server 505 sending an SMS OTP code to user 501 (e.g., to the user device associated with the phone number stored for the user), and an activity 534 of wallet server 505 sending a masked phone number (e.g., last four digits of the phone number) and a request to perform the SMS OTP step-up authentication to browser server 504. Next, process 530 can include an activity 536 of browser server 504 sending the masked phone number and the request to perform the SMS OTP step-up authentication to browser 503, after which browser 503 can perform an activity 538 of displaying the masked phone number and the OTP entry screen to request the user to enter the OTP code. The OTP entry screen can be similar or identical to verification code prompt 1010 (FIG. 10). Next, process 530 can include user 501 performing an activity 540 of entering the OTP code in merchant UI 502 on browser 503, after which browser 503 can perform an activity 542 of sending the OTP code to browser server 504, after which browser server 504 can perform an activity 544 of sending the OTP code to wallet server 505. In many embodiments, activity 544 can make a call similar to call 526 that can specify that the request is associated with an autofill, and can additionally include additional details, such as device data for the user device and/or browser, transaction data for the transaction, the OTP code, and/or other suitable information. Process 530 can next include wallet server 505 performing an activity 546 of validating the OTP code.

Process 550 for verification value step-up authentication using CVV, CVC, or other such verification method can include an activity 552 of wallet server 505 sending a request to perform the verification value step-up authentication to browser server 504. Next, process 550 can include an activity 554 of browser server 504 sending the request to perform the verification value step-up authentication to browser 503, after which browser 503 can perform an activity 556 of displaying the verification value entry screen to request the user to enter the verification value (e.g., CVV or CVC). Next, process 550 can include user 501 performing an activity 558 of entering the verification value in merchant UI 502 on browser 503, after which browser 503 can perform an activity 560 of sending the verification value to browser server 504, after which browser server 504 can perform an activity 562 of send the verification value to wallet server 505. In many embodiments, activity 562 can make a call similar to call 526 that can specify that the request is associated with an autofill, and can additionally include additional details, such as device data for the user device and/or browser, transaction data for the transaction, the verification value, and/or other suitable information. Process 550 can next include wallet server 505 sending a request 564 to card network 506 to validate the verification value of the card. If validated, card network 506 can send a response 566 to wallet server 505 that the verification value is confirmed and validated, and wallet server 505 can perform an activity 568 that acknowledges the successful completion of the step-up authentication process.

Next, method 500 can include wallet server 505 making a call 570 to token service provider 507 to get payment data for the autofill, after which token service provider 507 can provide a response 572 to wallet server 505 containing the payment data. Next, method 500 can include an activity 574 of wallet server 505 creating a secure payload, which can include the autofill payment token, the token expiration date, the DTVV and/or DTVC, and/or other suitable information. The payload can be secured by wallet server 505 encrypting the payload. Next, method 500 can perform an activity 576 of wallet server 505 sending the secure payload to browser server 504, after which browser server 504 can perform an activity 578 of decrypting the payload. Next, browser server 504 can perform an activity 580 of sending the payload to browser 503, after which browser 503 can perform an activity 582 of auto-populating (performing an autofill of) the card information in merchant UI 502 to display the autofill of card information to user 501. The card information can be similar or identical to the card information auto-populated in add card fields 620 of FIG. 11.

In many embodiments, method 500 can be compatible with a merchant website (e.g., merchant UI 502) that is directly registered with wallet server 505, such that the merchant website can make a call to wallet server 505 to get payment instruments such as all cards previously used and/or saved by user 501 including any wallet cards (which can be cards provided by wallet server 505). In such embodiments, when a user enters a transaction at a merchant registered with the wallet server, the transaction at the merchant may not interfere with the various activities and/or interactions associated with method 500.

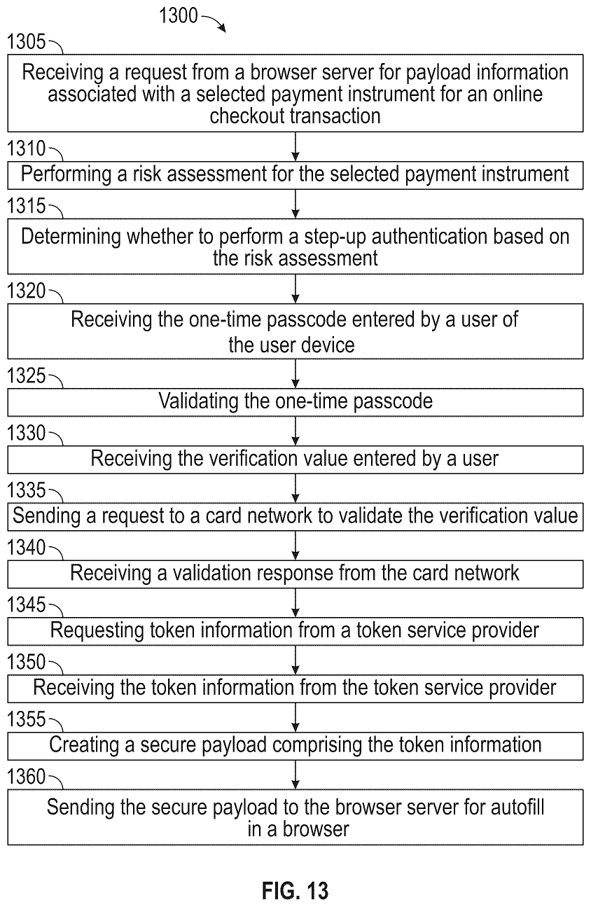

Turning ahead in the drawings, FIG. 13 illustrates a flowchart for a method 1300 of processing online checkout with browser autofill using a shared wallet, according to an embodiment. Method 1300 is merely exemplary and is not limited to the embodiments presented herein. Method 1300 can be employed in many different embodiments or examples not specifically depicted or described herein. In some embodiments, the procedures, the processes, and/or the activities of method 1300 can be performed in the order presented. In other embodiments, the procedures, the processes, and/or the activities of method 1300 can be performed in any suitable order. In still other embodiments, one or more of the procedures, the processes, and/or the activities of method 1300 can be combined or skipped.

In many embodiments, wallet server 350 (FIG. 3) and/or wallet server 505 (FIG. 5) can be suitable to perform method 1300 and/or one or more of the activities of method 1300. In these or other embodiments, one or more of the activities of method 1300 can be implemented as one or more computing instructions configured to run at one or more processors and configured to be stored at one or more non-transitory computer readable media. Such non-transitory computer readable media can be part of wallet server 350 (FIG. 3) and/or wallet server 505 (FIG. 5). The processor(s) can be similar or identical to the processor(s) described above with respect to computer system 100 (FIG. 1). In some embodiments, method 1300 and other activities in method 1300 can include using a distributed network including distributed memory architecture to perform the associated activity. This distributed architecture can reduce the impact on the network and system resources to reduce congestion in bottlenecks while still allowing data to be accessible from a central location.

Referring to FIG. 13, method 1300 can include an activity 1305 of receiving, at a wallet server, a request from a browser server for payload information associated with a selected payment instrument for an online checkout transaction. The wallet server can be similar or identical to wallet server 350 (FIG. 3) and/or wallet server 505 (FIG. 5). The browser server can be similar or identical to browser server 340 (FIG. 3) and/or browser server 504 (FIG. 5). The selected payment instrument can be similar or identical to payment instrument 731 (FIG. 7). The request can be similar or identical to call 526 (FIG. 5).

In several embodiments, method 1300 also can include an activity 1310 of performing, by the wallet server, a risk assessment for the selected payment instrument. The risk assessment can be similar or identical to activity 528 (FIG. 5).

In several embodiments, method 1300 additionally can include an activity 1315 of determining whether to perform a step-up authentication based on the risk assessment. In some embodiments, the step-up authentication can include sending a one-time passcode to a user device associated with the selected payment instrument and additional operations, such as activities 1320 and 1325 described below. The one-time passcode can be similar or identical to the OTP sent in activity 532 (FIG. 5). In the same or other embodiments, the step-up authentication can include requesting a verification value associated with the selected payment instrument and additional operations, such as activities 1330, 1335, and 1340, described below. The verification request for the verification value can be similar or identical to the request sent in activity 552 (FIG. 5).

In several embodiments, method 1300 optionally can include an activity 1320 of receiving, at the wallet server, the one-time passcode entered by a user of the user device. Activity 1320 can be similar or identical to wallet server 505 (FIG. 5) receiving the OTP code in activity 544 (FIG. 5).

In several embodiments, method 1300 further optionally can include an activity 1325 of validating, by the wallet server, the one-time passcode. Activity 1325 can be similar or identical to activity 546 (FIG. 5) of validating the OTP code.

In several embodiments, method 1300 optionally can include an activity 1330 of receiving, at the wallet server, the verification value entered by a user. Activity 1330 can be similar or identical to wallet server 505 (FIG. 5) receiving the verification value in activity 562 (FIG. 5).

In several embodiments, method 1300 further optionally can include an activity 1335 of sending, by the wallet server, a request to a card network to validate the verification value. Activity 1335 can be similar or identical to wallet server 505 (FIG. 5) sending request 564 (FIG. 5).

In several embodiments, method 1300 further optionally can include an activity 1340 of receiving, at the wallet server, a validation response from the card network. Activity 1340 can be similar or identical to wallet server 505 (FIG. 5) receiving response 566 (FIG. 5).

In several embodiments, method 1300 additionally can include an activity 1345 of, upon determining to proceed with the online checkout transaction, requesting, by the wallet server, token information from a token service provider. For example, if the risk assessment in activity 1310 and the step-up authentication (e.g., in steps 1315-1340) clears, then activity 1345 can be performed. The token service provider can be similar or identical to token service provider 370 (FIG. 3) and/or token service provider 507 (FIG. 5). Activity 1345 can be similar or identical to wallet server 505 (FIG. 5) making call 570 (FIG. 5) to token service provider 507 (FIG. 5) to get payment data for the autofill

In several embodiments, method 1300 further can include an activity 1350 of receiving, at the wallet server, the token information from the token service provider. Activity 1350 can be similar or identical to activity wallet server 505 (FIG. 5) receiving response 572 (FIG. 5).

In several embodiments, method 1300 additionally can include an activity 1355 of creating, by the wallet server, a secure payload comprising the token information. Activity 1355 can be similar or identical to activity 574 (FIG. 5). In some embodiments, the secure payload can include a token, an expiration date, and a dynamic verification value. In some embodiments, the dynamic verification value can be unique for the online checkout transaction. In many embodiments, the token can be a virtual card number of the card.

In several embodiments, method 1300 further can include an activity 1360 of sending, by the wallet server, the secure payload to the browser server for autofill in a browser. The browser can be similar or identical to browser 503 (FIG. 5). For example, the autofill can be similar or identical to the auto-population of add card fields 620 in FIG. 11, after which the user can submit the online checkout transaction, such as by selecting submit payment button 1220 (FIG. 12).

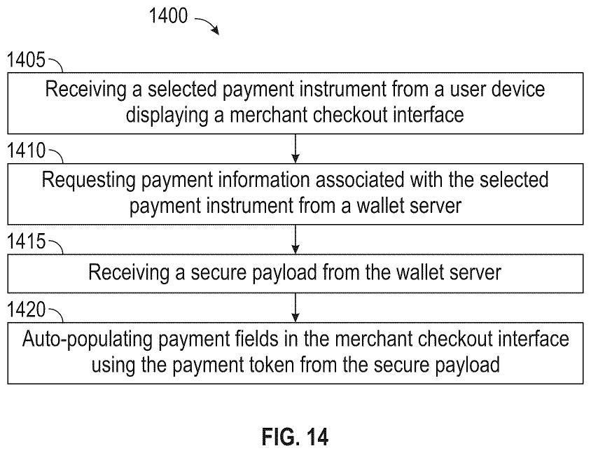

Turning ahead in the drawings, FIG. 14 illustrates a flowchart for a method 1400 of processing online checkout with browser autofill using a shared wallet, according to an embodiment. Method 1400 is merely exemplary and is not limited to the embodiments presented herein. Method 1400 can be employed in many different embodiments or examples not specifically depicted or described herein. In some embodiments, the procedures, the processes, and/or the activities of method 1400 can be performed in the order presented. In other embodiments, the procedures, the processes, and/or the activities of method 1400 can be performed in any suitable order. In still other embodiments, one or more of the procedures, the processes, and/or the activities of method 1400 can be combined or skipped.

In many embodiments, browser server 340 (FIG. 3) and/or browser server 504 (FIG. 5) can be suitable to perform method 1400 and/or one or more of the activities of method 1400. In these or other embodiments, one or more of the activities of method 1400 can be implemented as one or more computing instructions configured to run at one or more processors and configured to be stored at one or more non-transitory computer readable media. Such non-transitory computer readable media can be part of browser server 340 (FIG. 3) and/or browser server 504 (FIG. 5). The processor(s) can be similar or identical to the processor(s) described above with respect to computer system 100 (FIG. 1). In some embodiments, method 1400 and other activities in method 1400 can include using a distributed network including distributed memory architecture to perform the associated activity. This distributed architecture can reduce the impact on the network and system resources to reduce congestion in bottlenecks while still allowing data to be accessible from a central location.

Referring to FIG. 14, method 1400 can include an activity 1405 of receiving, at a browser server, a selected payment instrument from a user device displaying a merchant checkout interface. The browser server can be similar or identical to browser server 340 (FIG. 3) and/or browser server 504 (FIG. 5). The selected payment instrument can be similar or identical to payment instrument 731 (FIG. 7). The user device can be similar or identical to user device 320 (FIG. 3) and/or a user device used by user 501 (FIG. 5). The merchant checkout interface can be similar or identical to merchant user interface 502 (FIG. 5) and/or the user interface display screens shown in FIGS. 6-12. Activity 1405 can be similar or identical to call 524 (FIG. 5).

In several embodiments, method 1400 also can include an activity 1410 of requesting payment information associated with the selected payment instrument from a wallet server. The wallet server can be similar or identical to wallet server 350 (FIG. 3) and/or wallet server 505 (FIG. 5). Activity 1410 can be similar or identical to call 526 (FIG. 5).

In several embodiments, method 1400 additionally can include an activity 1415 of receiving a secure payload from the wallet server. Activity 1415 can be similar or identical to activity 576 (FIG. 5). In some embodiments, the secure payload can include a payment token.

In several embodiments, method 1400 additionally can include an activity 1420 of auto-populating payment fields in the merchant checkout interface using the payment token from the secure payload. For example, activity 1420 can be similar or identical to the auto-population of add card fields 620 in FIG. 11, after which the user can submit the online checkout transaction, such as by selecting submit payment button 1220 (FIG. 12).

In many embodiments, the techniques described herein can provide a practical application the provides technical improvements over conventional approaches. For example, the techniques described herein can provide technical improvements to online checkout systems by integrating browser autofill capabilities with secure shared wallet functionality. This integration can allow for seamless and efficient population of payment information during checkout while maintaining robust security measures. The techniques described herein can implement risk assessment and step-up authentication processes, which can include one-time passcodes or verification value checks, to ensure the legitimacy of transactions. Additionally, the use of tokenization and secure payload creation can enhance data protection by replacing sensitive payment card information with unique identifiers, reducing the risk of exposing actual card details during transmission and storage.

In practical applications, the techniques described herein can streamline the online transaction experience for users across multiple merchants and payment cards. Consumers can benefit from faster checkout processes as their payment information can be automatically populated from a shared wallet, reducing manual entry and potential errors. For merchants, the system can increase conversion rates by simplifying the payment process while still maintaining high security standards. The techniques described herein can work with various card networks and token service providers, which can provide flexibility and wide-ranging compatibility, allowing for easier integration with existing merchant transaction platforms and payment systems, which can result in reduced implementation costs for merchants and a more unified payment experience for consumers across different online stores.

Although systems and methods for processing online checkout using a shared wallet with browser autofill using a shared wallet has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-14 may be modified, and that the foregoing discussion of certain of these embodiments does not necessarily represent a complete description of all possible embodiments. For example, one or more of the procedures, processes, or activities of FIGS. 4-5 and 13-14 may include different procedures, processes, and/or activities and be performed by many different modules, in many different orders. As another example, the components within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
receiving, at a wallet server, a request from a browser server for payload information associated with a selected payment instrument for an online checkout transaction;
performing, by the wallet server, a risk assessment for the selected payment instrument;
determining whether to perform a step-up authentication based on the risk assessment;
upon determining to proceed with the online checkout transaction, requesting, by the wallet server, token information from a token service provider;
receiving, at the wallet server, the token information from the token service provider;
creating, by the wallet server, a secure payload comprising the token information; and
sending, by the wallet server, the secure payload to the browser server for autofill in a browser.

2. The computer-implemented method of claim 1, wherein the step-up authentication comprises sending a one-time passcode to a user device associated with the selected payment instrument.

3. The computer-implemented method of claim 2, further comprising:
receiving, at the wallet server, the one-time passcode entered by a user of the user device; and
validating, by the wallet server, the one-time passcode.

4. The computer-implemented method of claim 1, wherein the step-up authentication comprises requesting a verification value associated with the selected payment instrument.

5. The computer-implemented method of claim 4, further comprising:
receiving, at the wallet server, the verification value entered by a user;
sending, by the wallet server, a request to a card network to validate the verification value; and
receiving, at the wallet server, a validation response from the card network.

6. The computer-implemented method of claim 1, wherein the secure payload comprises a token, an expiration date, and a dynamic verification value.

7. The computer-implemented method of claim 6, wherein the dynamic verification value is unique for the online checkout transaction.

8. A system comprising one or more processors and one or more non-transitory computer-readable media storing computing instructions that, when executed on the one or more processors, cause the one or more processors to perform operations comprising:
receiving a request from a browser server for payload information associated with a selected payment instrument for an online checkout transaction;
performing a risk assessment for the selected payment instrument;
determining whether to perform a step-up authentication based on the risk assessment;
upon determining to proceed with the online checkout transaction, requesting token information from a token service provider;
receiving the token information from the token service provider;
creating a secure payload comprising the token information; and
sending the secure payload to the browser server for autofill in a browser.

9. The system of claim 8, wherein the step-up authentication comprises sending a one-time passcode to a user device associated with the selected payment instrument.

10. The system of claim 9, further comprising:
receiving the one-time passcode entered by a user of the user device; and
validating the one-time passcode.

11. The system of claim 8, wherein the step-up authentication comprises requesting a verification value associated with the selected payment instrument.

12. The system of claim 11, further comprising:
receiving the verification value entered by a user;
sending a request to a card network to validate the verification value; and
receiving a validation response from the card network.

13. The system of claim 8, wherein the secure payload comprises a token, an expiration date, and a dynamic verification value.

14. The system of claim 13, wherein the dynamic verification value is unique for the online checkout transaction.

15. One or more non-transitory computer-readable media storing computing instructions that, when executed on one or more processors, cause the one or more processors to perform operations comprising:
receiving a request from a browser server for payload information associated with a selected payment instrument for an online checkout transaction;
performing a risk assessment for the selected payment instrument;
determining whether to perform a step-up authentication based on the risk assessment;
upon determining to proceed with the online checkout transaction, requesting token information from a token service provider;
receiving the token information from the token service provider;
creating a secure payload comprising the token information; and
sending the secure payload to the browser server for autofill in a browser.

16. The one or more non-transitory computer-readable media of claim 15, wherein the step-up authentication comprises sending a one-time passcode to a user device associated with the selected payment instrument.

17. The one or more non-transitory computer-readable media of claim 16, further comprising:
receiving the one-time passcode entered by a user of the user device; and
validating the one-time passcode.

18. The one or more non-transitory computer-readable media of claim 15, wherein the step-up authentication comprises requesting a verification value associated with the selected payment instrument.

19. The one or more non-transitory computer-readable media of claim 18, further comprising:
receiving the verification value entered by a user;
sending a request to a card network to validate the verification value; and
receiving a validation response from the card network.

20. The one or more non-transitory computer-readable media of claim 15, wherein:
the secure payload comprises a token, an expiration date, and a dynamic verification value; and
the dynamic verification value is unique for the online checkout transaction.
